(19) United States
(12) Patent Application Publication
(10) Pub. No.: US 2009/0268652 A1
(43) Pub. Date: Oct. 29, 2009

(54) Power management mode aware mesh beacon collision avoidance and information update mechanism

(75) Inventors: Jarkko Kneckt, Espoo (FI); Mika Kasslin, Espoo (FI); Janne Marin, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/150,726

(22) Filed: Apr. 29, 2008

(51) Int. Cl. G08C 17/00

(52) U.S. Cl. 370/311

(57) ABSTRACT

Apparatus, methods and computer program products provide power management mode aware mesh beacon collision avoidance and information update mechanisms at a first mesh point in a wireless mesh network. The information update mechanism operates by detecting that a timing-related beacon transmission parameter of the first mesh point has changed; generating a message containing updated timing-related beacon transmission parameter information for the first mesh point; determining when a second mesh point operating in a power saving mode will transition to an awake state; and transmitting the message containing the updated timing-related beacon transmission information during a time corresponding to the awake state of the second mesh point.

### TECHNICAL FIELD

The exemplary and non-limiting embodiments of this invention relate generally to wireless communication systems, methods, devices and computer program products and, more specifically, relate to signaling and power saving modes in networks such as, for example wireless local area mesh and ad-hoc networks.

### BACKGROUND

The following abbreviations are utilized herein:

ACK acknowledgement (acknowledgement message)
AP access point
ATIM announcement traffic indication message
BSS basic service set
DTIM delivery traffic indication message
GAS generic advertisement service
IBSS independent basic service set
IEEE institute of electrical and electronics engineers
MAC medium access control (layer 2, L2)
MAP mesh access point
MBCA mesh beacon collision avoidance
MDA mesh deterministic access
MP mesh point
MPP mesh portal
MSDU MAC service data unit
PS power save
STA station
TBTT target beacon transmission time
TIM traffic indication message
WLAN wireless local area network

Local and larger metropolitan wireless area networks are becoming of increasing interest, particularly in view of the adoption of Wi-Fi capability in handheld devices. When within range of a wireless network, Wi-Fi capability gives a hand-held device, e.g., a cell phone, the ability to connect to the internet through a local hot spot, instead of through a wireless telephone connection with a cellular carrier. This often results in faster performance, as transactions necessary to service, e.g., browsing activity, are streamlined and simpler in a Wi-Fi connection when compared to a connection through an active telephone connection with a cellular carrier.

These advances raise issues of how best to implement network access and how to coordinate the activities of devices facilitating network access. In one possible implementation, the coordination of devices within radio range is achieved by the exchange of beacon frames. Periodic beacon transmission enables device discovery, supports dynamic network organization, and provides support for mobility.

In proposed wireless local area network (WLAN) deployments without mesh services, stations (STAs) must associate with an access point in order to gain access to the network. These stations are dependent on the access point (AP) with which they are associated to communicate. An example of a nonmesh WLAN deployment model 100 and device classes 120, 130 are depicted in FIG. 1. Stations 130 are connected through access points 120 to external network 110.

Many WLAN devices can benefit from support for more flexible wireless connectivity. Functionally, the distribution system of an access point can be replaced with wireless links or multihop paths between multiple access points. Devices traditionally categorized as clients can benefit from the ability to establish peer-to-peer wireless links with neighboring clients and access points in a mesh network.

An example of a mesh network 200 is depicted in FIG. 2. Mesh points (MPs) 224 are entities that support mesh services, i.e., they participate in the formation and operation of the mesh network. A mesh point 224 may be collocated with one or more other entities (e.g., an access point 232, portal 222, etc.). The configuration of a mesh point 224 that is collocated with an access point 232 is referred to as a mesh access point (MAP) 230. Such a configuration allows a single entity to logically provide both mesh functionalities and access point functionalities simultaneously. Stations 240 associate with access points to gain access to the network 210. Only mesh points participate in mesh functionalities such as path selection and forwarding, etc. Mesh portals (MPPs) 220 comprised of a mesh point 224 and portal 220 interface the network to other LAN segments.

In one exemplary implementation, a “Mesh network model” is envisioned as an IEEE 802 LAN comprised of IEEE 802.11 links and control elements to forward frames among the network members. Effectively, this means that a mesh network appears functionally equivalent to a broadcast ethernet from the perspective of other networks and higher layer protocols. Thus, it normally appears as if all MPs in a mesh are directly connected to the link layer. This functionality is transparent to higher layer protocols. Reference in this regard can be made to FIG. 3A. Here a mesh service data unit (MSDU) is transmitted in network 300 from MSDU source 310 to MSDU destination 320 over a multi-hop network of mesh points 330. It should be noted that while this figure shows the forwarding of data over multiple hops, there may also be direct data transfer over a single hop, such as is shown in ad-hoc 1-hop networking model 350 of FIG. 3B, wherein the source and destination of the MSDUs are within a one-hop neighborhood through mesh points 360, and where no forwarding, routing or link metric need be used.

In an infrastructure basic service set (BSS) stations rely on the access point for power saving. A station informs the access point before switching from active to power save mode. If any station in BSS operates in power save mode the access point buffers multicast and broadcast traffic and delivers the traffic after the delivery traffic indication message (DTIM) period. The DTIM interval is a multiple of beacon periods. For unicast traffic that is buffered in the access point, stations periodically need to wake up to receive the traffic indication map (TIM) that is present in all beacon frames. Having learned from a beacon frame that unicast traffic directed to the station is pending, a station sends out a power save (PS)-Poll frame to request the traffic's delivery from the AP.

In an independent basic service set (IBSS) mode, also known as ad-hoc, the basic approach is similar to the infrastructure BSS case in that the stations are synchronized, and multicast traffic and the traffic that are to be transmitted to a power-conserving station are first announced during a period when all stations are awake. The announcement is performed via a message sent in an announcement traffic indication message (ATIM) window. A station in the power save mode shall listen for these announcements to determine if it needs to remain in the awake state. The presence of the ATIM window in the IBSS indicates if the station may use the PS Mode. To maintain correct information on the power save state of other stations in an IBSS, a station needs to remain awake during the ATIM window. At other times the station may enter the doze state.

For example, in one possible implementation two different power states may be specified. In the awake state the mesh point is able to transmit or receive frames and is fully powered, while in the doze state the mesh point is not able to transmit or receive and consumes very low power. The transitions between these two power states are determined by the mesh point power management modes, i.e., an active mode where the mesh point shall be in the awake state all the time and the power save mode where the mesh point alternates between awake and doze states. There may be further power save modes, for example, a deep sleep mode where the mesh point transmits its delivery traffic indication message (DTIM) beacon and stays active during its own awake window after its DTIM beacon. Another mode may be a light sleep mode. If a peer mesh point operates in this mode the mesh point transmits its traffic indication map (TIM) and DTIM beacons and stays awake during its awake window after its DTIM beacon and after its TIM beacon with the awake window information element. The mesh point listens to all the beacons from all peer mesh points to which it has indicated to operate in light sleep mode.

Further rules for how the communication to and from the mesh point in power save can be triggered are defined. The mesh point which transmitted the beacon may operate in the awake state until it has received a trigger frame from all peer mesh points which have indicated to operate in a power save mode where they are listening to beacons (e.g. light sleep mode), and the beaconing mesh point has indicated availability of buffered traffic for the peer mesh points in its beacon frame. However, the nature of the radio environment and protocol is such that the mesh point cannot be sure that all peer mesh points which have indicated to operate in such a power save mode have received the beacon. Thus, if the peer mesh point does not receive the beacon correctly, the mesh point does not know that it should transmit a trigger frame to the beaconing mesh point. In this case the beaconing mesh point must stay in the awake state until it receives a frame from the peer mesh point which can be interpreted as a trigger frame, or indicates in its own consecutive beacon that it does not have any frames to transmit.

The operation in deep sleep mode may be defined in such a way so that the mesh point in deep sleep is only transmitting its own DTIM beacon and the mesh point is not mandated to listen for any peer mesh point beacons. In practice even the deep sleep mode mesh point may have occasional reasons to transmit some frames to peer mesh point for example for routing purposes or even link maintenance purposes.

However, the problem is that currently the clock accuracy in WLAN is not very good and if a (deep sleep) mesh point does not receive any peer MPs' beacons, the clock drifts and the mesh point is not aware when peer mesh point is transmitting its beacon. Now when (deep sleep) mesh point wants to send data to peer mesh points it might want to receive peer mesh point beacons but it has to scan for a long time in order to receive one.

### SUMMARY

An aspect of the exemplary embodiments of the invention is a method comprising: at a first mesh point in a wireless mesh network, detecting that a beacon transmission parameter of the first mesh point has changed; generating a message containing updated beacon transmission parameter information; determining when a second mesh point operating in a power saving mode will transition to an awake state; and transmitting the message containing the updated beacon transmission information during a time corresponding to the awake state of the second mesh point.

In a variant of this aspect of the exemplary embodiments of the invention detecting that a beacon transmission parameter of the first mesh point has changed further comprises detecting that the first mesh point will initiate use of mesh deterministic access. In such a variant, generating a message containing updated beacon transmission information further comprises incorporating in the message an indication that the first mesh point will begin using mesh deterministic access.

In another variant of this aspect of the exemplary embodiments of the invention, detecting that a beacon transmission parameter has changed further comprises determining that a timing-related parameter has changed. In such a variant, generating a message containing updated beacon transmission parameter information further comprises incorporating in the message updated timing-related beacon transmission parameter information.

Another aspect of the exemplary embodiments of the invention is a device comprising: radio apparatus configured to perform bidirectional communication operations in a wireless mesh network, wherein the bidirectional communication operations comprise at least transmission of a beacon; and a controller, when the device is operating as a first mesh point, that is configured to detect that a beacon transmission parameter of the first mesh point has changed; to generate a message containing updated beacon transmission parameter information; to determine when a second mesh point operating in a power saving mode will transition to an awake state; and to operate the radio apparatus to transmit the message containing the updated beacon transmission information during a time corresponding to the awake state of the second mesh point.

In a variant of this other aspect of the exemplary embodiments of the invention to detect that a beacon transmission parameter has changed further comprises to detect that the device will begin using mesh deterministic access. In such a variant to generate a message containing updated beacon transmission parameter information further comprises to incorporate in the message an indication that the device will initiate use of mesh deterministic access.

In another variant of this other aspect of the exemplary embodiments of the invention, to detect that a beacon transmission parameter has changed further comprises to detect that a timing-related beacon transmission parameter has changed. In such a variant, to generate a message containing updated beacon transmission parameter information further comprises to incorporate in the message updated timing-related beacon transmission parameter information.

A further aspect of the exemplary embodiments of the invention is a computer program product comprising a computer readable memory medium tangibly embodying a computer program, the computer program, when executed, configured to cause a device operating as a first mesh point in a wireless mesh network to detect that a beacon transmission parameter of the first mesh point has changed; to generate a message containing updated beacon transmission parameter information; to determine when a second mesh point operating in a power saving mode will transition to an awake state; and to operate radio apparatus to transmit the message containing the updated beacon transmission parameter information during a time corresponding to the awake state of the second mesh point.

In a variant of this further aspect of the exemplary embodiments of the invention to detect that a beacon transmission parameter has changed further comprises to detect that the device will begin using mesh deterministic access. In such a variant to generate a message containing updated beacon transmission parameter information further comprises to incorporate in the message an indication that the device will initiate use of mesh deterministic access.

In another variant of this further aspect of the exemplary embodiments of the invention, to detect that a beacon transmission parameter has changed further comprises to detect that a timing-related beacon transmission parameter has changed. In such a variant, to generate a message containing updated beacon transmission parameter information further comprises to incorporate in the message updated timing-related beacon transmission parameter information.

Yet another aspect of the exemplary embodiments of the inventions is a method comprising: at a first mesh point operative in a wireless mesh network, detecting that beacons being transmitted by second and third mesh points are colliding; determining whether the first mesh point has a peer relationship with the second and third mesh points; deciding how to transmit mesh beacon collision information, at least in part, in dependence on the outcome of the peer relationship determination; and transmitting a message containing the mesh beacon collision avoidance information.

A still further aspect of the exemplary embodiments of the invention is a device comprising: radio apparatus configured to perform bidirectional communication operations in a wireless mesh network, wherein the bidirectional communication operations comprise at least transmission of a beacon; and a controller, when the device is operating as a first mesh point, that is configured to detect that beacons being transmitted by second and third mesh points are colliding; to determine whether the first mesh point has a peer relationship with the second and third mesh points; to decide how to transmit mesh beacon collision information, at least in part, in dependence on the outcome of the peer relationship determination; and to transmitting a message containing the mesh beacon collision avoidance information.

An aspect of the exemplary embodiments of the invention is a computer program product comprising a computer readable memory medium tangibly embodying a computer program, the computer program, when executed, configured to cause a device operating as a first mesh point in a wireless mesh network to detect that beacons being transmitted by second and third mesh points are colliding; to determine whether the first mesh point has a peer relationship with the second and third mesh points; to decide how to transmit mesh beacon collision information, at least in part, in dependence on the outcome of the peer relationship determination; and to transmitting a message containing the mesh beacon collision avoidance information.

Another aspect of the exemplary embodiments of the invention is a method comprising: at a second mesh point operative in a wireless mesh network, receiving a message containing updated beacon transmission parameter information from a first mesh point; and determining when to transition to an awake state from a power save mode in dependence on the updated beacon transmission parameter information.

A further aspect of the exemplary embodiments of the invention is a device comprising: radio apparatus configured to perform bidirectional communication operations in a wireless mesh network, wherein the bidirectional communication operations comprise at least reception of a beacon; and a controller, when the device is operating as a second mesh point, that is configured to operate the radio apparatus to receive a message containing updated beacon transmission parameter information from a first mesh point; and to determine when to transition the device to an awake state from a power save mode in dependence on the updated beacon transmission parameter information.

Yet another aspect of the exemplary embodiments of the invention is a computer program product comprising a computer readable memory medium tangibly embodying a computer program, wherein the computer program, when executed, is configured to cause a device operating as a second mesh point in a wireless mesh network: to operate radio apparatus to receive a message containing updated beacon transmission parameter information from a first mesh point; and to determine when to transition the device to an awake state from a power save mode in dependence on the updated beacon transmission parameter information.

### BRIEF DESCRIPTION OF THE DRAWINGS

In the attached Drawing Figures:

FIG. 1 shows a nonmesh IEEE 802.11 deployment model and device classes;

FIG. 2 shows a mesh containing MPs, MAPs, and STAs;

FIG. 3A shows MAC data transport over a mesh;

FIG. 3B depicts an exemplary ad-hoc one hop networking model;

FIG. 4 shows a simplified block diagram of various electronic devices that are suitable for use in practicing the exemplary embodiments of this invention;

FIG. 5 depicts an exemplary unicast Beacon Parameter Update frame in accordance with the invention;

FIG. 6A depicts the info field of the unicast Beacon Parameter Update frame of FIG. 5 in greater detail in embodiments indicating that a timing-related parameter has changed;

FIG. 6B depicts the info field of the unicast Beacon Parameter Update frame of FIG. 5 in greater detail in embodiments where use of mesh deterministic access will be initiated;

FIG. 7 is a flow chart depicting a method operating in accordance with an exemplary embodiment of the invention;

FIG. 8 is a flow chart depicting another method operating in accordance with an exemplary embodiment of the invention;

FIG. 9 is a flow chart depicting a method operating in accordance with an exemplary embodiment of the invention;

FIG. 10 is a flow chart depicting another method operating in accordance with an exemplary embodiment of the invention;

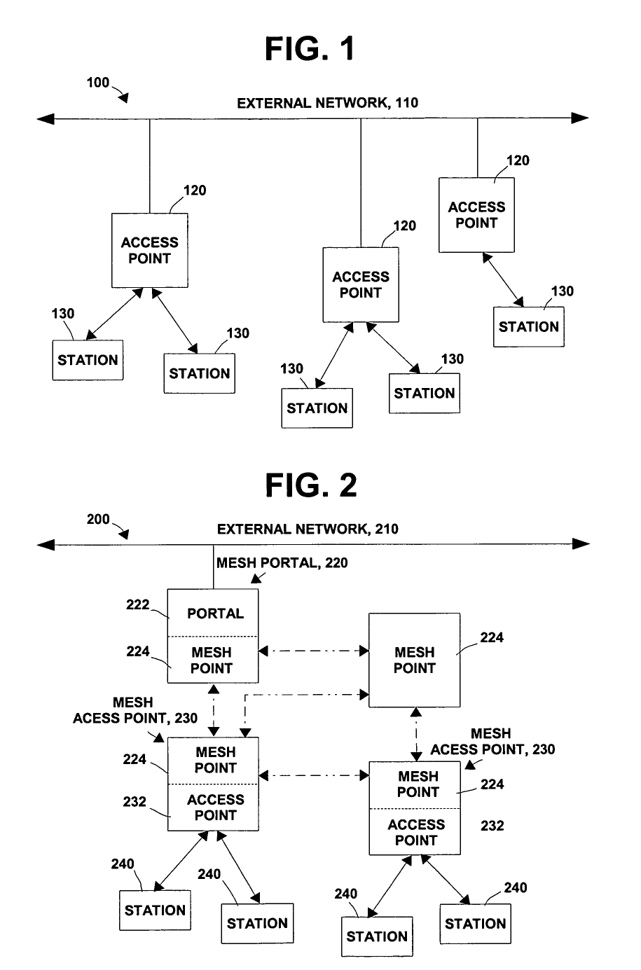

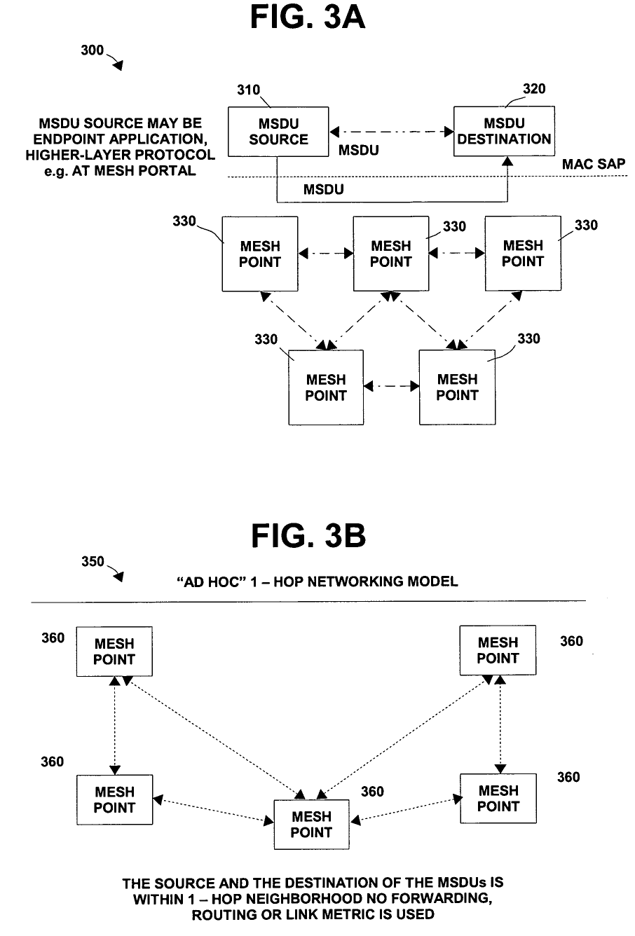

### DETAILED DESCRIPTION

In this invention method and apparatus is provided that permits all mesh points (MPs) to receive mesh beacon collision avoidance information and deep sleep MPs to receive indications if peer MPs beacon transmission time has changed. This enables the power saving MPs to benefit from the Mesh Beacon Collision Avoidance (MBCA) mechanism and peer MPs may help a deep sleep MP to maintain (or achieve) more accurate synchronization with its peer MPs.

As described in more detail below, the exemplary embodiments of the invention provide power saving in WLAN mesh networks, in ad-hoc networks and in other wireless networks.

The use of the exemplary embodiments of the invention provide an assurance that there will exist some predefined duration of time when a neighboring MP knows that another MP is accessible, and also provides an assurance that all MPs can return to a power save state, for example to the doze state, after the predefined duration of time expires. Both of these features may be realized using the same mechanism.

Regarding a first device and a second device in a wireless mesh network (e.g., an IEEE 802.11s mesh network), the second device is considered a “peer MP” of the first device if there is an authenticated communication link between the first device and the second device (i.e., a communication link with one or more messages being directed from/to the first device to/from the second device, also referred to as a peer link). A non-peer MP is only able to use frames, which do not require authentication, when communicating with the other MP. Non-limiting examples of such frames include probe requests, peer link open frames or generic advertisement service (GAS) query frames. As an example, a non-peer may receive a beacon from a first device and respond with a frame in an attempt to establish a peer relationship with the first device.

For reference purposes, a “beaconing MP” refers to the MP that transmits the beacon. Generally, this term will be used in conjunction with a non-peer MP that receives the beacon from the beaconing MP and desires to establish a peer relationship by responding to the beacon (i.e., transmitting a frame to the beaconing MP).

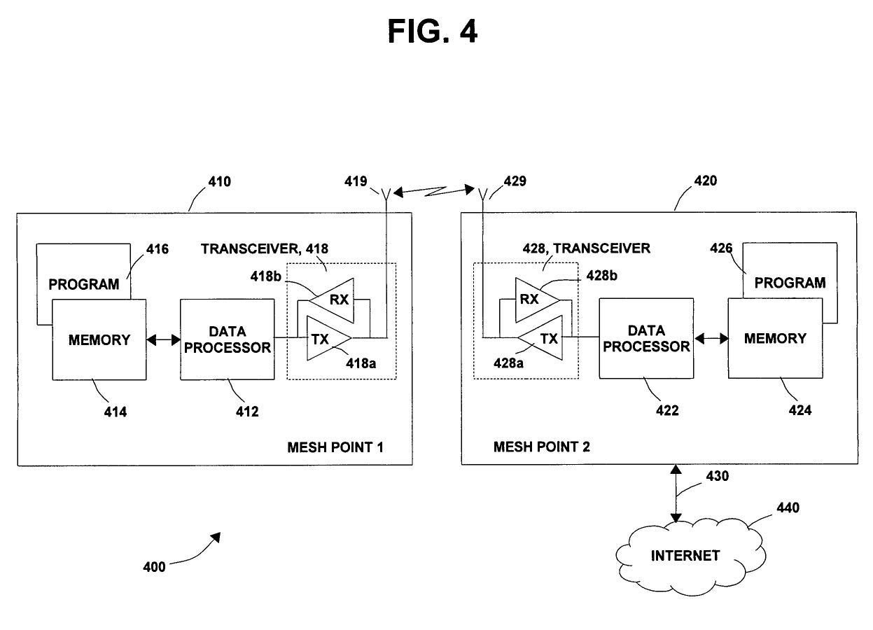

Reference is made to FIG. 4 for illustrating a simplified block diagram of various electronic devices that are suitable for use in practicing the exemplary embodiments of this invention. In FIG. 4, a wireless network 400 is adapted for communication with a first mesh point (Mesh Point 1) 410 via a second mesh point (Mesh Point 2) 420. Mesh Point 1 410 includes a control unit or controller, such as one comprising a data processor 412, a memory 414 coupled to the data processor 412, and a suitable RF transceiver 418 (having a transmitter (TX) 418a and a receiver (RX) 418b) coupled to the data processor 412. The memory 414 stores a program 416. The transceiver 418 is for bidirectional wireless communications with Mesh Point 2 420. Note that the transceiver 418 has at least one antenna 419 to facilitate communication.

Mesh Point 2 420 includes a data processor 422, a memory 424 coupled to the data processor 422, and a suitable RF transceiver 428 (having a transmitter (TX) 428a and a receiver (RX) 428b) coupled to the data processor 422. The memory 424 stores a program 426. The transceiver 428 is for bidirectional wireless communications with Mesh Point 1 410. Note that the transceiver 428 has at least one antenna 429 to facilitate communication. Mesh Point 2 420 is coupled via a data path 430 to one or more additional mesh points, external networks or systems, such as the internet 440, for example. Furthermore, the Mesh Point 1 410 may also be coupled via a data path (not shown) to one or more additional mesh points, external networks or systems, such as the internet, for example.

At least one of the programs 416, 426 is assumed to include program instructions that, when executed by the associated data processor, enable the electronic device to operate in accordance with the exemplary embodiments of this invention, as discussed herein.

In general, the various exemplary embodiments of the Mesh Point 1 410 can include, but are not limited to, cellular phones, mobile terminals, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as units or terminals that incorporate combinations of such functions.

The exemplary embodiments of this invention may be implemented by computer software executable by one or more of the data processors 412, 422 of the Mesh Point 1 410 and the Mesh Point 2 420, or by hardware, or by a combination of software and hardware. As a non-limiting example, one or more of the individual components of Mesh Point 1 410 and/or Mesh Point 2 420 may be implemented utilizing one or more Integrated Circuits (ICs) or Application Specific Integrated Circuits (ASICs).

The memories 414, 424 may be of any type suitable to the local technical environment and may be implemented using any suitable data storage technology, such as semiconductor based memory devices, magnetic memory devices and systems, optical memory devices and systems, fixed memory and removable memory, as non-limiting examples. The data processors 412, 422 may be of any type suitable to the local technical environment, and may include one or more of general purpose computers, special purpose computers, microprocessors, digital signal processors (DSPs) and processors based on a single-core or multi-core processor architecture, as non-limiting examples.

As presently specified the mesh points 410, 420 that transmitted the beacon is to remain in the awake state until the end of the awake window, and until a multicast (MC) or broadcast (BC) frame with data bit set to 0 is transmitted, whichever occurs later. In addition, the MP 410, 420 that is in a power save mode is to listen to the beacon and continue to receive MC/BC frames, or a beacon frame which indicates that all MC and BC frames are transmitted.

With the foregoing as background, a description of the invention will now be presented. In a first example the invention adds synchronization information to existing management frames as a new information element (IE). In another example the synchronization information is transmitted in a unicast management frame like a beacon parameter update frame. The functionality is the same in both cases. The synchronization information included contains the reference times when peer mesh points of the mesh point which sent the information are in a wake state (i.e., a sending beacon). The synchronization information may contain also information for beacon transmission periodicity or timing changes.

The information includes the following items:

1) Reference (to which beacon next timing references are coupled)

2) Peer-mesh-point-related information
a) MAC address (or other unique identifier in the network)
b) beacon transmission time
c) beacon interval
   The latter (item #2) may be more than once in management frame or in IE.

The mesh point uses beacon timing information to inform a peer mesh point that may operate in deep sleep mode if its beacon transmission time or periodicity has changed and improve the peer mesh point's knowledge when the mesh point is awake. If the beaconing parameters of the mesh point change, the mesh point shall transmit information of its changed beacon transmission times to all peer mesh points that are in the deep sleep mode. If the peer mesh point in deep sleep mode does not get information of the changed beaconing parameters, a peer mesh point may need to perform long scanning to discover the changed parameters.

The new management frame (or adding the IE) should be used if the mesh point which changes its beacon transmission times indicates the new transmission times to its peer mesh points that operate in deep sleep mode.

In a second aspect of the invention, if a mesh point A detects that beacons from mesh point B are colliding with beacons from mesh point C, the mesh point A should check to see if it has a peer relationship with the mesh point B or mesh point C (or both). If a peer relationship exists the mesh point A shall select the mechanism to indicate the mesh beacon collision:
Use own beacon to carry MBCA information if the peer mesh points operate in light or active mode.
Use unicast management frame to carry MBCA information if the peer mesh points operates in deep sleep mode.

If the MP has a peer relationship with both MPs that transmit beacons at collision times, the MP should transmit the MBCA indication to the highest powered MP only. If the MP has peer link with two MPs in deep sleep which beacons collide, the MP should transmit the information on the colliding beacons only to the other MP.

If the MP does not have a peer relationship, it may include MBCA information in its beacon or transmit unicast management frame to carry MBCA information.

In another example, management frames can be used to transmit an indication that a mesh point will begin using mesh deterministic access (MDA) to transmit information. As in the prior example regarding a change in a timing-related beacon transmission parameter, mesh deterministic access as heretofore envisioned, has not been designed to operate with mesh points that may operate in power save modes. Mesh deterministic access is a deterministic access scheme that allows MDA-capable mesh points to transmit high access-category information content in a deterministic manner.

MDA coordination mechanisms improve data transmission efficiency and might reduce power consumption. The mesh points that are using MDA, i.e. are capable to propose or accept new MDA reservation, should have an understanding of the existing MDA reservations in the neighborhood. The existing reservations are notified periodically and the power saving MPs monitor these notifications periodically.

The compatibility of power save and MDA is achieved through defining rules for

(1) Collecting information of the existing MDA reservations before starting to use MDA;

(2) Informing other (power saving) MPs on the MDA usage; and

(3) Operation during the MDA Opportunities (MDAOP), Peer Service Period utilization with MDA.

Before MDA can be used certain preconditions have to be met. First, a mesh point must be MDA capable. Second, a mesh point must have a set MDA enabled bit. A mesh point may have a set MDA Enabled bit, if it is aware of neighboring mesh points' MDA reservations and reported TX-RX times. A mesh point is considered to be aware of neighboring mesh points' MDA reservations after listening media for example for 1-2 seconds. Third, a mesh point has informed its change to MDA enabled mode to MDA enabled non-peer mesh points operating in power save mode and to MDA enabled peer mesh points operating in deep sleep.

After MDA enabled bit is set, the mesh point may make and accept MDA reservations.

A mesh point informs other mesh points of its intention to use MDA as follows. A mesh point sends unicast “notify” message containing information of the beacon transmission times and that MDA Enabled bit will be set. The notify frames may be transmitted during the scanning of MDA reservations in the neighborhood. MDA enabled mesh points shall monitor MDA announcements in order to maintain MDA utilization information.

Peer service period is used as follows in combination with MDA. A peer service period is triggered at the MDAOP start time, if the receiver MP in MDAOP operates in light or deep sleep power management mode for the transmitter MP in MDAOP. The MDAOP transmitter is the transmitter in triggered peer service period. The MDAOP receiver is the receiver in triggered peer service period. No peer service period is triggered, if the receiver MP in MDAOP operates in active mode for the transmitter MP.

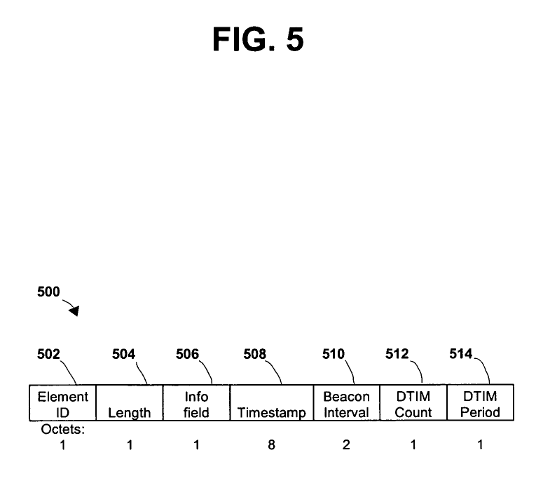

More detailed information of the unicast beacon parameter update frame 500 follows. The frame is transmitted to MPs operating in deep sleep to notify the change of the beaconing parameters or to update the time reference. The frame 500 is transmitted as management frame and in an exemplary and non-limiting embodiment its format is specified as depicted in FIG. 5.

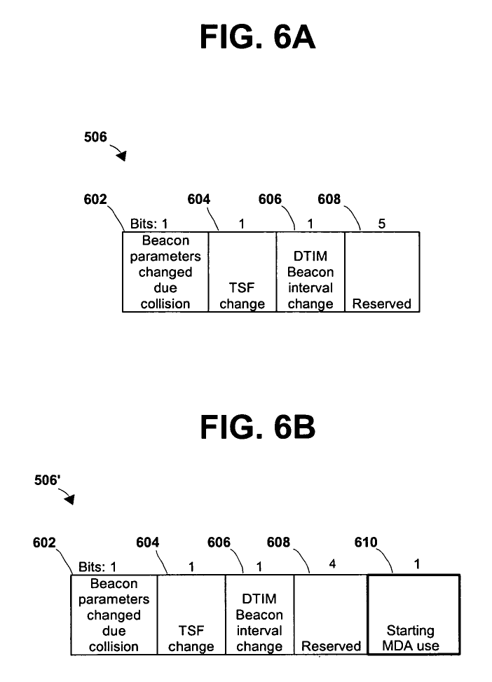

The element ID 502 identifies the information element. The length field 504 identifies the length of the information element. In this example it is set to 13. The Info field 506 is one octet in length and represents information elements as shown in FIG. 6A. The Beacon parameters changed bit 602 is set to 1, if the beacon parameters are changed as a response to the Mesh Beacon Collision Avoidance indication and 0 otherwise. Timing synchronization function (TSF) Change bit 604 is set to 1 if the TSF field of the message transmitter is modified to new value and set to 0 otherwise. The DTIM Beacon interval change bit 608 is set to 1, if the DTIM beacon interval or Beacon interval field is changed and set to 0 otherwise. In FIG. 6A five bits 608 are reserved.

In embodiment 506′ involving use of MDA, an additional bit is included as shown in FIG. 6B, “starting MDA bit” 610. The bit is set to 1, when the mesh point is using or will initiate using MDA. The bit is set to zero when the mesh point is not using or will not use MDA.

Referring back to FIG. 5, the Timestamp field 508 is 8 octets in length and represents the value of the TSF timer of a frame's source. The Beacon Interval field 510 is 2 octets in length and represents the number of time units (TUs) between target beacon transmission times (TBTTs). The DTIM Count field 512 indicates how many beacons (including the current frame) appear before the next DTIM. A DTIM Count of 0 indicates that the current TIM is a DTIM. The DTIM count field is a single octet. The DTIM Period field 514 indicates the number of Beacon intervals between successive DTIMs. If all TIMs are DTIMs, the DTIM Period field has the value 1. The DTIM Period value 0 is reserved. The DTIM period field is a single octet.

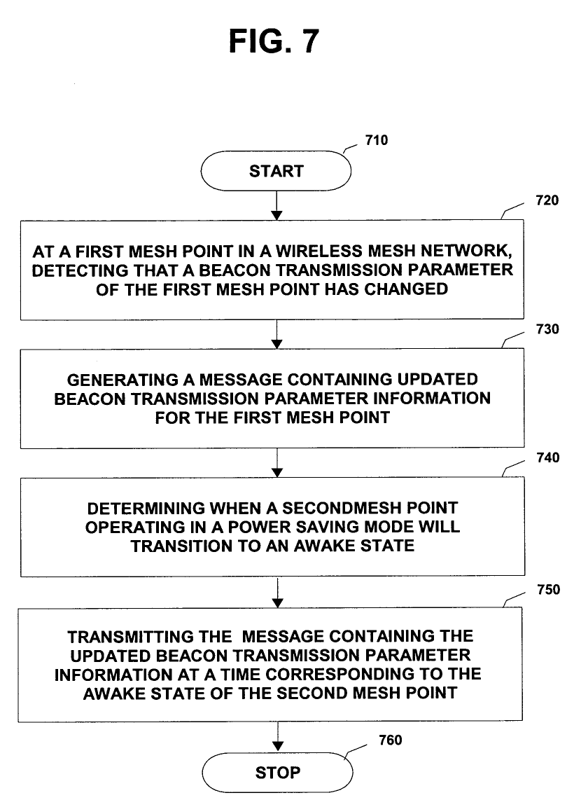

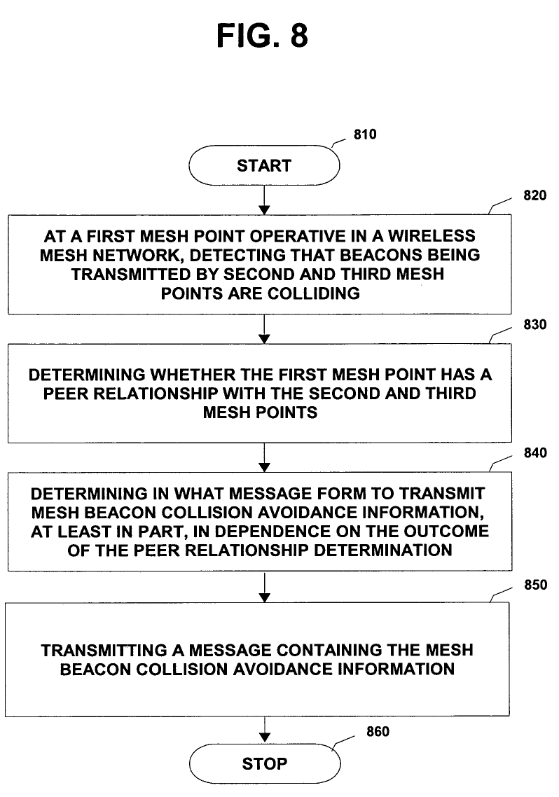

FIGS. 7 and 8 summarize exemplary embodiments of the invention involving transmitting updated timing-related beacon transmission parameter information to mesh points capable of operating in power save modes. In FIG. 7, the method starts at 710. Then, at 720, a first mesh point operative in a wireless mesh network detects that a beacon transmission parameter of the first mesh point has changed. The beacon transmission parameter might include, for example, peer-mesh-point-related information like MAC address (or other unique identifier in the network) or timing-related beacon transmission parameters, for example, a reference to which beacon next timing references are coupled; a beacon transmission time; or a beacon interval. Next, at 730, the mesh point generates a message containing updated beacon transmission parameter information for the first mesh point. Then, at 740, the mesh point determines when a second mesh point operating in a power saving mode will transition to an awake state. Next, at 750, the first mesh point transmits the message containing the updated beacon transmission information at a time corresponding to the awake state of the second mesh point. The method stops at 760.

The method depicted in FIG. 8 starts at 810. Then, at 820, a first mesh point operative in a wireless mesh network detects that beacons being transmitted by second and third mesh points are colliding. Next, at 830, the first mesh point determines whether the first mesh point has a peer relationship with the second and third mesh points. Then, at 840, the first mesh point determines in what message form to transmit mesh beacon collision avoidance information, at least in part, in dependence on the outcome of the peer relationship determination. Next, at 850, the first mesh point transmits a message containing the mesh beacon collision avoidance information like beacon reception timing report or selected TBTT. The method stops at 860.

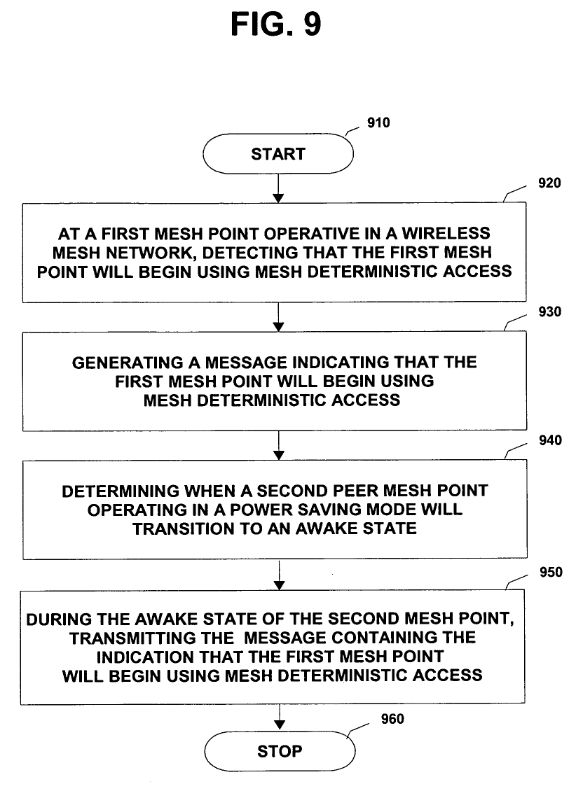

FIG. 9 summarizes exemplary embodiments of the invention involving transmitting an indication that a mesh point will begin using mesh deterministic access using a beacon transmission parameter message. The method starts at 910. Then, at 920, at a first mesh point operative in a wireless mesh network, the first mesh point detects that it will begin using mesh deterministic access to transmit information. Next, at 930, the first mesh point generates a message (e.g., a beacon transmission parameter message) indicating that it will begin using mesh deterministic access. Then, at 940, the first mesh point determines when a second mesh point operating in a power saving mode will transition to an awake state. Next, at 950, during the awake state of the second mesh point, the first mesh point transmits the message containing the indication that the first mesh point will begin using mesh deterministic access. The method stops at 960.

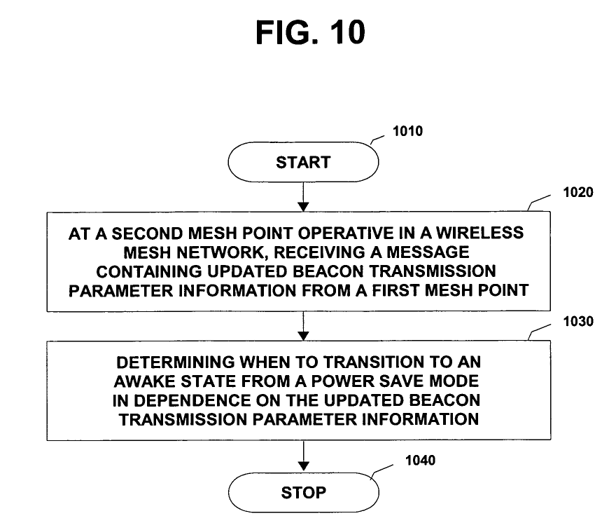

FIG. 10 summarizes exemplary embodiments of the invention involving receiving a message containing updated beacon transmission parameter information at a second mesh point operative in a wireless mesh network. The method begins at 1010. Next, at 1020, a second mesh point operating in a wireless mesh network receives a message containing updated beacon transmission parameter information from a first mesh point. Then, at 1030, the second mesh point determines when to transition to an awake state from a power save mode in dependence on the updated beacon transmission parameter information. The method stops at 1040.

The updated beacon transmission information may contain updated timing-related beacon transmission parameter information, or an indication that a mesh point will begin using mesh deterministic access to transmit messages.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
at a first mesh point in a wireless mesh network, detecting that a beacon transmission parameter of the first mesh point has changed;
generating a message containing updated beacon transmission parameter information;
determining when a second mesh point operating in a power saving mode will transition to an awake state; and
transmitting the message containing the updated beacon transmission information during a time corresponding to the awake state of the second mesh point.

2. The method of claim 1 wherein detecting that a beacon transmission parameter of the first mesh point has changed further comprises determining that the first mesh point will initiate use of mesh deterministic access.

3. The method of claim 2 wherein generating a message containing updated beacon transmission information further comprises incorporating in the message an indication that the first mesh point will begin using mesh deterministic access.

4. The method of claim 2 further comprising scanning the wireless mesh network for mesh-deterministic-access-capable mesh points currently using mesh deterministic access.

5. The method of claim 1 wherein detecting that a beacon transmission parameter has changed further comprises determining that a timing-related parameter has changed.

6. The method of claim 5 further comprising:
identifying the second mesh point as a peer mesh point.

7. The method of claim 6 wherein generating a message containing updated beacon transmission parameter information further comprises incorporating in the message updated timing-related beacon transmission parameter information.

8. The method of claim 7 wherein the updated timing-related beacon transmission parameter information further comprises synchronization information.

9. The method of claim 8 wherein the synchronization information indicates when the first mesh point is in an awake state.

10. The method of claim 8 wherein the synchronization information comprises at least a timing change.

11. The method of claim 8 wherein the synchronization information comprises at least a periodicity change.

12. A device comprising:
radio apparatus configured to perform bidirectional communication operations in a wireless mesh network, wherein the bidirectional communication operations comprise at least transmission of a beacon; and
a controller, when the device is operating as a first mesh point, that is configured to detect that a beacon transmission parameter has changed;
to generate a message containing updated beacon transmission parameter information;
to determine when a second mesh point operating in a power saving mode will transition to an awake state; and
to operate the radio apparatus to transmit the message containing the updated beacon transmission information during a time corresponding to the awake state of the second mesh point.

13. The device of claim 12 wherein to detect that a beacon transmission parameter has changed further comprises to detect that the device will begin using mesh deterministic access.

14. The device of claim 13 wherein to generate a message containing updated beacon transmission parameter information further comprises to incorporate in the message an indication that the device will initiate use of mesh deterministic access.

15. The device of claim 13 wherein the controller is further configured to control the device to scan for mesh-deterministic-access-capable mesh points that are currently using mesh deterministic access.

16. The device of claim 12 wherein to detect that a beacon transmission parameter has changed further comprises to detect that a timing-related beacon transmission parameter has changed.

17. The device of claim 16 wherein the controller is further configured to identify the second mesh point as a peer mesh point.

18. The device of claim 17 wherein to generate a message containing updated beacon transmission parameter information further comprises to incorporate in the message updated timing-related beacon transmission parameter information.

19. A computer program product comprising a computer readable memory medium tangibly embodying a computer program, the computer program, when executed, configured to cause a device operating as a first mesh point in a wireless mesh network to detect that a beacon transmission parameter has changed;
to generate a message containing updated beacon transmission parameter information;
to determine when a second mesh point operating in a power saving mode will transition to a awake state; and
to operate radio apparatus to transmit the message containing the updated beacon transmission parameter information during a time corresponding to the awake state of the second mesh point.

20. The computer program product of claim 19 wherein to detect that a beacon transmission parameter has changed further comprises to detect that the device will begin using mesh deterministic access.

21. The computer program product of claim 20 wherein to generate a message containing updated beacon transmission parameter information further comprises to incorporate in the message an indication that the device will initiate use of mesh deterministic access.

22. The computer program product of claim 20 wherein the computer program, when executed, is further configured to control the device to scan for mesh-deterministic-access-capable mesh points that are currently using mesh deterministic access.

23. The computer program product of claim 19 wherein to detect that a beacon transmission parameter has changed further comprises to detect that a timing-related beacon transmission parameter has changed.

24. The computer program product of claim 23 wherein the computer program, when executed, is further configured to control the device to identify the second mesh point as a peer mesh point.

25. The computer program product of claim 24 wherein to generate a message containing updated beacon transmission parameter information further comprises to incorporate in the message updated timing-related beacon transmission parameter information.

26. A method comprising:
at a first mesh point operative in a wireless mesh network, detecting that beacons being transmitted by second and third mesh points are colliding;
determining whether the first mesh point has a peer relationship with the second and third mesh points;
deciding how to transmit mesh beacon collision information, at least in part, in dependence on the outcome of the peer relationship determination; and
transmitting a message containing the mesh beacon collision avoidance information.

27. The method of claim 26 further comprising:
if it is determined that the first mesh point has a peer relationship with the second and third mesh points, determining what power saving mode the second and third mesh points are in.

28. The method of claim 27 further comprising: if it is determined that the second and third mesh points are in a light sleep or active mode, deciding how to transmit mesh beacon collision information further comprises using a beacon of the first mesh point to carry the mesh beacon collision information.

29. The method of claim 27 further comprising: if it is determined that the second and third mesh points are in a deep sleep mode, deciding how to transmit mesh beacon collision information further comprises using a unicast management frame to carry the mesh beacon collision information.

30. The method of claim 26 further comprising:
if it is determined that the first mesh point does not have a peer relationship with the second and third mesh points, deciding how to transmit mesh beacons collision information further comprises using a beacon of the first mesh point to carry the mesh beacon collision information.

31. The method of claim 26 further comprising:
if it is determined that the first mesh point does not have a peer relationship with the second and third mesh points, deciding how to transmit mesh beacons collision information further comprises using a unicast management frame to carry the mesh beacon collision information.

32. A device comprising:
radio apparatus configured to perform bidirectional communication operations in a wireless mesh network, wherein the bidirectional communication operations comprise at least transmission of a beacon; and
a controller, when the device is operating as a first mesh point, that is configured to detect that beacons being transmitted by second and third mesh points are colliding;
to determine whether the first mesh point has a peer relationship with the second and third mesh points;
to decide how to transmit mesh beacon collision information, at least in part, in dependence on the outcome of the peer relationship determination; and
to transmit a message containing the mesh beacon collision avoidance information.

33. The device of claim 32 wherein the controller, if it is determined that the first mesh point has a peer relationship with the second and third mesh points, is further configured to determine what power saving mode the second and third mesh points are in.

34. A computer program product comprising a computer readable memory medium tangibly embodying a computer program, wherein the computer program, when executed, is configured to cause a device operating as a first mesh point in a wireless mesh network:
to detect that beacons being transmitted by second and third mesh points are colliding;
to determine whether the first mesh point has a peer relationship with the second and third mesh points;
to decide how to transmit mesh beacon collision information, at least in part, in dependence on the outcome of the peer relationship determination; and
to transmit a message containing the mesh beacon collision avoidance information.

35. The computer program product of claim 34 wherein when the computer program is executed, if it is determined that the first mesh point has a peer relationship with the second and third mesh points, the computer program is further configured to cause the device operating as a first mesh point to determine what power saving mode the second and third mesh points are in.

36. A method comprising:
at a second mesh point operative in a wireless mesh network, receiving a message containing updated beacon transmission parameter information from a first mesh point; and
determining when to transit to an awake state from a power save mode in dependence on the updated beacon transmission parameter information.

37. The method of claim 36 wherein the updated beacon transmission parameter information further comprises an indication that the first mesh point will begin using mesh deterministic access.

38. The method of claim 36 wherein the updated beacon transmission parameter information further comprises updated timing-related beacon transmission parameter information.

39. A device comprising:
radio apparatus configured to perform bidirectional communication operations in a wireless mesh network, wherein the bidirectional communication operations comprise at least transmission of a beacon; and
a controller, when the device is operating as a second mesh point, that is configured to operate the radio apparatus to receive a message containing updated beacon transmission parameter information from a first mesh point; and
to determine when to transition the device to an awake state from a power save mode in dependence on the updated beacon transmission parameter information.

40. The device of claim 39 wherein the updated beacon transmission parameter information further comprises an indication that the first mesh point will begin using mesh deterministic access.

41. The device of claim 39 wherein the updated beacon transmission parameter information further comprises updated timing-related beacon transmission parameter information.

42. A computer program product comprising a computer readable memory medium tangibly embodying a computer program, wherein the computer program, when executed, is configured to cause a device operating as a second mesh point in a wireless mesh network:
to operate radio apparatus to receive a message containing updated beacon transmission parameter information from a first mesh point; and
to determine when to transition the device to an awake state from a power save mode in dependence on the updated beacon transmission parameter information.

43. The computer program product of claim 42 wherein the updated beacon transmission parameter information further comprises an indication that the first mesh point will begin using mesh deterministic access.

44. The computer program product of claim 42 wherein the updated beacon transmission parameter information further comprises updated timing-related beacon transmission parameter information.
